(19) United States
(12) Patent Application Publication
(10) Pub. No.: US 2026/0010821 A1
(43) Pub. Date: Jan. 8, 2026

(54) INCREMENTAL LEARNING CLASSIFICATION CAPABILITIES

(71) Applicant: AUTOBRAINS TECHNOLOGIES LTD, Tel Aviv-Yafo (IL)

(72) Inventors: Igal RAICHELGAUZ, Tel Aviv (IL); Shay LEIZEROVITCH, Mikhmoret (IL)

(73) Assignee: AUTOBRAINS TECHNOLOGIES LTD, Tel Aviv-Yafo (IL)

(21) Appl. No.: 18/765,332

(22) Filed: Jul. 8, 2024

(51) Int. Cl. G06N 20/00

(52) U.S. Cl. CPC G06N 20/00

(57) ABSTRACT

A method for incremental learning classification capabilities, the method includes identifying, at each iteration of an iterative incremental learning process, that an embedding exhibits a clustering confidence level that is below a threshold, the embedding, generated at least in part by a machine learning process, representing a detector output that is responsive to a sensed information unit; identifying, at each iteration by accessing a data structure associated with one or more reference detector output, signatures that are similar to a signature of the detector output; and determining, at each iteration, an additional cluster for an embedding associated with the detector output and for reference embeddings associated with the one or more reference detector output signatures. Such that at each iteration of the iterative incremental process the identifying is based on at least one more determined cluster than a preceding iteration, and road elements associated with embeddings that fall within the determined cluster exhibit a clustering confidence level that is above the threshold and are classified, during inference, in accordance with the determined cluster.

### BACKGROUND

Neural networks are employed in vehicles for various purposes including the classification of items sensed by sensors related to the vehicle, and providing responses related to driving based on the classification on items.

There is a growing need to increase the accuracy of classification, even when the initial classification process is inaccurate.

### SUMMARY

A method, system and non-transitory computer readable medium as illustrated in the application.

### A BRIEF DESCRIPTION OF THE DRAWINGS

The embodiments of the disclosure will be understood and appreciated more fully from the following detailed description, taken in conjunction with the drawings in which:

FIG. 1 illustrates an example of a system;

FIG. 2 illustrates an example of a vehicle;

FIG. 3 illustrates an example of a method; and

FIG. 4 illustrates an example of a method.

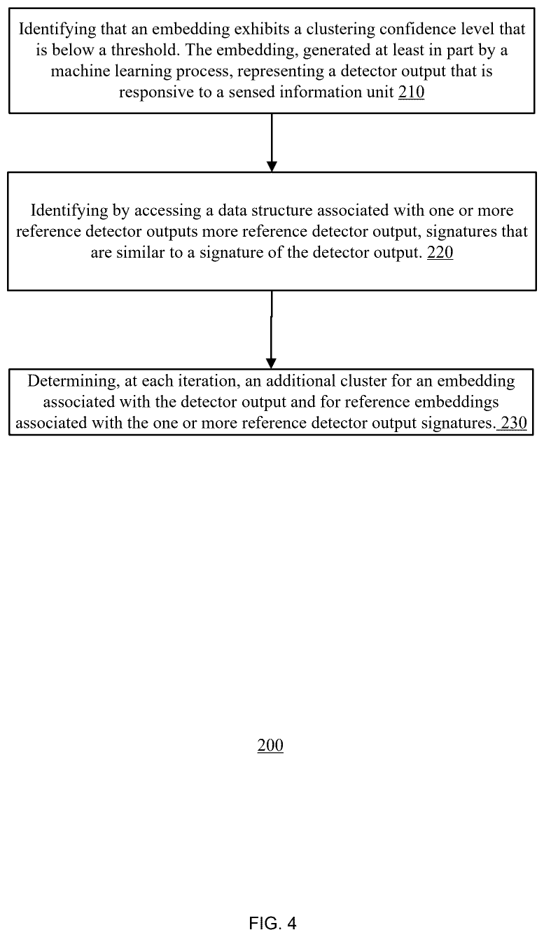

### DETAILED DESCRIPTION

The different figures illustrates examples of units and/or software and/or information items and/or steps and/or components. These examples are provided for brevity of explanation. At least one of the units and/or software and/or information items and/or steps and/or components is optional or mandatory.

According to an embodiment there is provided a method, a non-transitory computer readable medium and a computerized system for incremental learning classification. The method is iterative and over time identifies items associated with a below threshold classification confidence and provides an additional cluster that allows to classify the items with a classification confidence that exceeds the threshold. Each iterations increase the items that are properly classified thereby providing an incremental learning.

As the number of iterations increases—the method manages to properly classify more and more items—including rare items that may belong to the long tail of items to be classified.

As the number of iterations increase—the method improves its classification capabilities and may impose more strict requirements on the detection—thereby increasing the threshold.

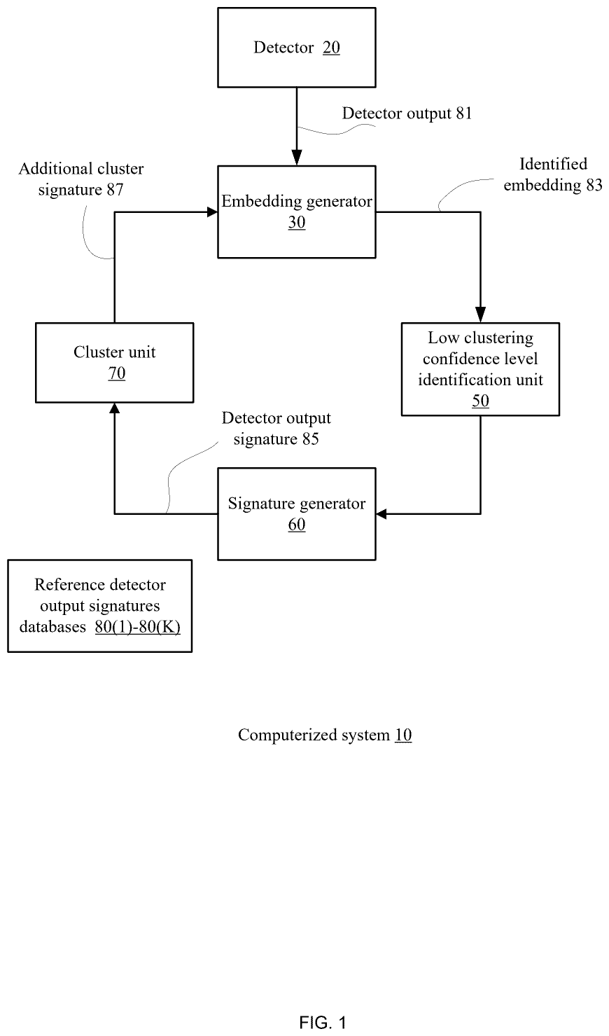

FIG. 1 illustrates an example of a computerized system 10 used to implement method 100.

Computerized system 10 includes a detector 20, an embedding generator 30, a low clustering confidence level identification unit 50, signature generator 60 and cluster unit 70.

According to an embodiment, detector 20, embedding generator 30, low clustering confidence level identification unit 50, signature generator 60 and cluster unit 70 are implemented by using one or more processing circuit configured to execute instructions stored in one or more non-transitory computer readable medium.

An example for a detector and an embedding generator are illustrated in U.S. patent application Ser. No. 18/595,368 filing date Mar. 4, 2024 which is incorporated herein by reference.

According to an embodiment, embedding generator 30, low clustering confidence level identification unit 50, signature generator 60 and cluster unit 70 cooperate in providing the incremental learning.

According to an embodiment, during an iteration of the incremental learning:
A. Low clustering confidence level identification unit 50 is configured to identify that an embedding exhibits a clustering confidence level that is below a threshold, the embedding, generated by embedding generator 30 at least in part by a machine learning process, representing a detector output (outputted from detector 20) that is responsive to a sensed information unit.
B. Cluster unit 70 is configured to identify, by accessing a data structure associated with one or more reference detector outputs in a classification similarity to the detector output, reference detector output signatures in a classification similarity to a detector output signature that is associated with the identified embedding.
C. Embedding generator 30 is further configured to produce the reference embeddings in association with the one or more reference detector outputs.
D. Cluster unit 70 is further configured to determine, based on the producing, an additional cluster for both the reference embeddings and the identified embedding.

According to an embodiment, at each iteration of the iterative incremental process implemented by computerized system 10, the identifying is based on at least one more additional cluster than a preceding iteration, and road elements associated with embeddings that fall within the additional cluster exhibit a clustering confidence level that is above the threshold and are classified, during inference, in accordance with the additional cluster.

According to an embodiment, the obtained detector output includes a region of interest indicator related to a specified region of interest. The region of interest indicator may be a bounding box.

According to an embodiment, the obtained detector output is indicative of a region of the sensed information to be used by a cropping process to generate a cropped sensed information unit.

According to an embodiment, the obtained detector output includes an initial classification of an item captured by the region of interest.

According to an embodiment, the generating of the detector output signature is in correlation with a signature associated with the identified embedding. For example—the output detector signature may be used for calculating the identified embedding. Yet for another example—the identified embedding is used for calculating the output detector signature.

An example for a signature, a cropping and an embedding is illustrated in U.S. patent application Ser. No. 18/595,368, which is incorporated herein by reference.

According to an embodiment, threshold changes over time. For example—the threshold is increased with an increase in a number of iterations of the iterative incremental learning process.

According to an embodiment, the identified embedding is associated with an initial classification (related to the cluster to which the embedding was associated with a lower than threshold confidence level). According to an embodiment, the computerized system is configured to determine that the initial classification is a faulty classification when the initial classification differs from a classification associated with an additional cluster determined during the iteration.

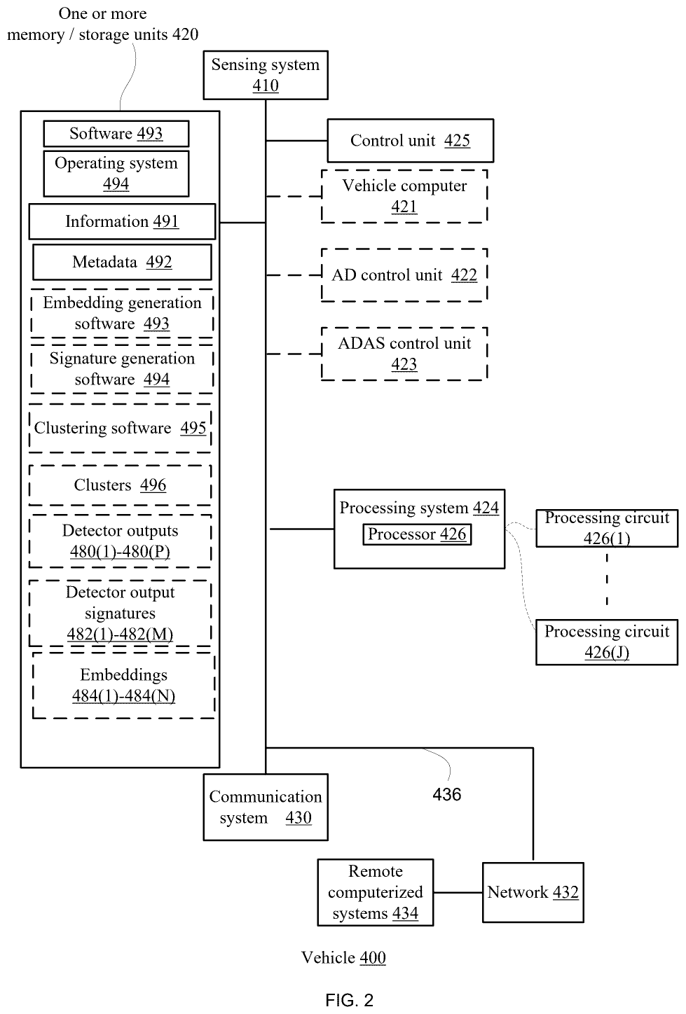

FIG. 2 illustrates an example of a vehicle 400.

Vehicle 400 includes communication system 430, one or more memory and/or storage units 420, processing system 424 including processor 426. The communication system 430, the one or more memory and/or storage units 420, and the processing system 424 may belong to a computerized system of vehicle 400. The computerized system may be a server, a laptop, a desktop or any other computer and may include or be in communication with a sensing unit and/or a controller.

According to an embodiment, vehicle 400 is in communication with network 432 and one or more other remote computerized systems 434 that are in communication with network 432. An example of a remote computerized system is a server or one or more computers having access to a storage system that stores items related to one or more portions of one or more groups of neural networks—at least some of which are not currently stored in the vehicle.

According to an embodiment, the communication system 430 is configured to enable communication between the one or more memory and/or storage units 420 and/or any one of the additional units and/or the network 432 (that is in communication with the remote computerized systems). Communication system 430 is also configured to enable communication with other elements such as sensing system 410, control unit 425, vehicle computer 421, autonomous driving control unit 422 (denoted AD control unit), advanced driver assistance system (ADAS) control unit 423 (denoted ADAS control unit), and the like.

The memory and/or storage units 420 was shown as storing software. Any reference to software should be applied mutatis mutandis to code and/or firmware and/or instructions and/or commands, and the like.

Processor 426 includes a plurality of processing units 426(1)-426(J), J is an integer that exceeds one. Any reference to one unit or item should be applied mutatis mutandis to multiple units or items. For example—any reference to processor should be applied mutatis mutandis to multiple processors, any reference to communication system 430 should be applied mutatis mutandis to multiple communication systems.

According to an embodiment, the one or more memory and/or storage units 420 includes one or more memory unit, each memory unit may include one or more memory banks.

According to an embodiment, the one or more memory and/or storage units 420 includes a volatile memory and/or a non-volatile memory. The one or more memory and/or storage units 420 may be a random-access memory (RAM) and/or a read only memory (ROM).

According to an embodiment, the non-volatile memory unit is a mass storage device, which can provide non-volatile storage of computer code, computer readable instructions, data structures, program modules, and other data for the processor or any other unit of vehicle. For example, and not meant to be limiting, a mass storage device can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any content may be stored in any part or any type of the memory and/or storage units.

According to an embodiment, the at least one memory unit stores at least one database—such as any database known in the art—such as DB2®, Microsoft® Access, Microsoft® SQL Server, Oracle®, mySQL, PostgreSQL, and the like.

The memory and/or storage units 420 are configured to store firmware and/or software, one or more operating systems, data and metadata required to the execution of any of the methods mentioned in this application.

The memory and/or storage units 420 was shown as storing software. Any reference to software should be applied mutatis mutandis to code and/or firmware and/or instructions and/or commands, and the like.

Various units and/or components are in communication with each other using any communication elements and/or protocols. An example of a communication system is denoted 430. Other communication elements may be provided.

The communication system 430 may be in communication with bus 436. The bus represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus, and all buses specified in this description can also be implemented over a wired or wireless network connection and each of the subsystems.

Network 432 that is located outside the vehicle and is used for communication between the vehicle and at least one remote computing system. By way of example, a remote computing system can be a personal computer, a laptop computer, portable computer, a server, a router, a network computer, a peer device or other common network node, and so on. Logical connections between the processor and either one of remote computing systems can be made via a local area network (LAN) and a general wide area network (WAN). Such network connections can be through a network adapter (may belong to communication system 430) which can be implemented in both wired and wireless environments. Such networking environments are conventional and commonplace in offices, enterprise-wide computer networks, intranets, and a larger network such as the internet.

It should be noted that at least a part of the content illustrated as being stored in one or more memory/storage units 420 may be stored outside the vehicle. It should also be noted that the processor may evaluate signatures generated by a plurality of detectors.

Examples of generating signatures and/or cropping images are provided in U.S. patent application Ser. No. 18/527,701 which is incorporated herein by reference.

According to an embodiment, the memory and/or storage units 420 stores at least one of: operating system 494, information 491, metadata 492, and software 493.

Examples of software includes embedding generation software 493 for generating embeddings, signature generation software 494 for generating signatures, and clustering software 495 for generating clusters and performing any other cluster related operation such as determining clustering confidence levels, performing cluster based classification, and the like. Examples of information include detector outputs 480(1)-480(P), detector output signatures 482(1)-482(M), embeddings 484(1)-484(N). The detector outputs may include detector output 81 and reference detector outputs. The detector output signatures may include detector output signature 85 and reference detector output signatures.

The control unit 425 may cooperate with ADAS control unit 423 and/or with AD control unit 482 and/or may control or communicate with other vehicle components—including vehicle computer.

The ADAS control unit 423 is configured to control ADAS operations.

The AD control unit 422 is configured to control autonomous driving of the autonomous vehicle.

The vehicle computer 421 is configured to control the operation of the vehicle—especially controlling the engine, the transmission, and any other vehicle system or component.

The vehicle computer 421 may be in communication with an engine control module, a transmission control module, a powertrain control module, and the like.

The sensing system 410 may include optics, a sensing element group, a readout circuit, and an image signal processor. Optics are followed by a sensing element group such as line of sensing elements or an array of sensing elements that form the sensing element group. The sensing element group is followed by a readout circuit that reads detection signals generated by the sensing element group. An image signal processor is configured to perform an initial processing of the detection signals—for example by improving the quality of the detection information, performing noise reduction, and the like. The sensing system 410 is configured to output one or more sensed information units (SIUs).

The control unit 425 is configured to control the operation of the sensing system 410, and/or the one or more memory and/or storage units 420 and/or the one or more additional units (except the controller).

By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by a computer.

Any content may be stored in any part or any type of the memory and/or storage units.

According to an embodiment, the at least one memory unit stores at least one database—such as any database known in the art—such as DB2®, Microsoft® Access, Microsoft® SQL Server, Oracle®, mySQL, PostgreSQL, and the like.

Various units and/or components are in communication with each other using any communication elements and/or protocols. An example of a communication system is denoted 430. Other communication elements may be provided.

According to an embodiment, processing system 424 is configured to perform, while executing software and during an iteration of the incremental learning:
A. Identify that an embedding exhibits a clustering confidence level that is below a threshold, the embedding, generated by embedding generator 30 at least in part by a machine learning process, representing a detector output (outputted from detector 20) that is responsive to a sensed information unit.
B. Identify, by accessing a data structure associated with one or more reference detector outputs in a classification similarity to the detector output, reference detector output signatures in a classification similarity to a detector output signature that is associated with the identified embedding.
C. Produce the reference embeddings in association with the one or more reference detector outputs.
D. Determine, based on the producing, an additional cluster for both the reference embeddings and the identified embedding.

According to an embodiment, at each iteration of the iterative incremental process implemented by the processing circuit, the identifying is based on at least one more additional cluster than a preceding iteration, and road elements associated with embeddings that fall within the additional cluster exhibit a clustering confidence level that is above the threshold and are classified, during inference, in accordance with the additional cluster.

According to an embodiment, processing system 424 is configured to perform, while executing software and during an iteration of the incremental learning:
A. Identify, at each iteration of an iterative incremental learning process, that an embedding exhibits a clustering confidence level that is below a threshold, the embedding, generated at least in part by a machine learning process, representing a detector output that is responsive to a sensed information unit.
B. Identify, at each iteration by accessing a data structure associated with one or more reference detector output, signatures that are similar to a signature of the detector output.
C. Determining, at each iteration, an additional cluster for an embedding associated with the detector output and for reference embeddings associated with the one or more reference detector output signatures.

The execution of A-C by the processing circuit results in having each iteration of the iterative incremental process the identifying is based on at least one more determined cluster than a preceding iteration, and road elements associated with embeddings that fall within the determined cluster exhibit a clustering confidence level that is above the threshold and are classified, during inference, in accordance with the determined cluster.

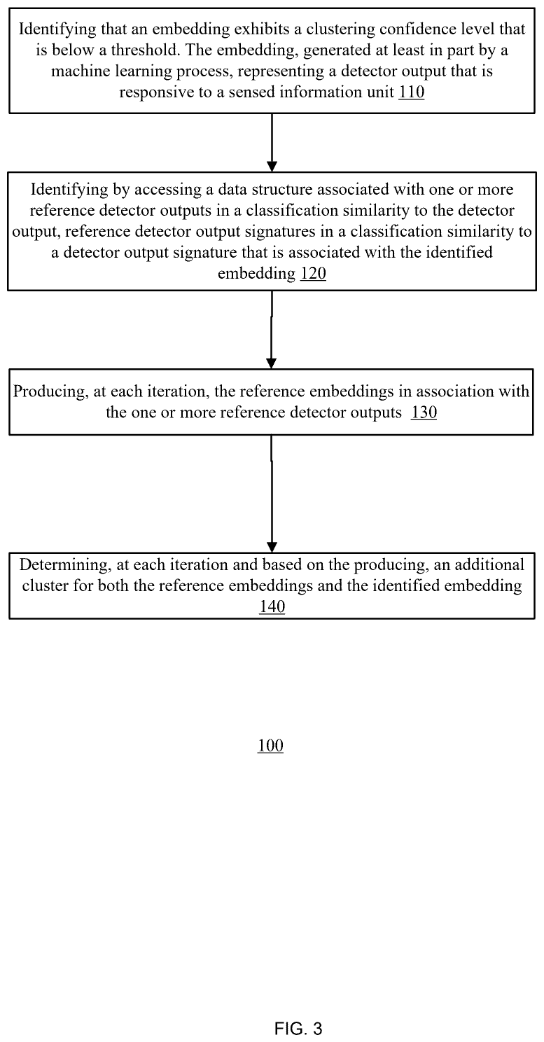

FIG. 3 illustrates an example of method 100 for incremental learning classification capabilities, the method is computer implemented.

According to an embodiment, method 100 includes repeating, for each iteration of an iterative incremental learning:
A. Step 110 of identifying that an embedding exhibits a clustering confidence level that is below a threshold. The embedding, generated at least in part by a machine learning process, representing a detector output that is responsive to a sensed information unit.
B. Step 120 of identifying by accessing a data structure associated with one or more reference detector outputs in a classification similarity to the detector output, reference detector output signatures in a classification similarity to a detector output signature that is associated with the identified embedding.
C. Step 130 of producing, at each iteration, the reference embeddings in association with the one or more reference detector outputs.
D. Step 140 of determining, at each iteration and based on the producing, an additional cluster for both the reference embeddings and the identified embedding.

According to an embodiment, at each iteration of the iterative incremental process the identifying is based on at least one more additional cluster than a preceding iteration, and road elements associated with embeddings that fall within the additional cluster exhibit a clustering confidence level that is above the threshold and are classified, during inference, in accordance with the additional cluster.

According to an embodiment, the number of iterations is unlimited.

According to an embodiment, the number of iteration is limited to a defined maximal number of iterations.

According to an embodiment an iteration refers to a case in which an embedding exhibits a clustering confidence level that is below a threshold. It is expected that in most cases embeddings are associated with clustering confidence levels above the threshold.

According to an embodiment the iterations end when the method converges.

Examples of convergence rules include:
A. When all the cases relevant to driving are properly classified.
B. When the application of the method achieves at least a desired classification accuracy—for example reaches a classification accuracy of at least 99, 99.9, 99.99, 99.999, 99.9999, 99.99999 percent accuracy.
C. When the application of the method achieves at least a desired tradeoff between at least two of false positive, false negative, true positive and true negative.
D. When a contribution of an iteration to the overall accuracy of classification is below a defined added accuracy value—for example below an accuracy improvement of 1-10 percent of the accuracy.

According to an embodiment, the threshold is determined in any manner—for example by simulation, by testing, by a vendor, by a client, by a vehicle manufacturer, and the like.

According to an embodiment, the threshold is determined to comply with a defined allowable value of false positive and/or an allowable value of false negative, and/or to provide a desired tradeoff between at least two of false positive, false negative, true positive and true negative.

According to an embodiment, the obtained detector output includes a region of interest indicator related to a specified region of interest. The region of interest indicator may be a bounding box.

According to an embodiment, the obtained detector output is indicative of a region of the sensed information to be used by a cropping process to generate a cropped sensed information unit.

According to an embodiment, the obtained detector output includes an initial classification of an item captured by the region of interest.

According to an embodiment, the generating of the detector output signature is in correlation with a signature associated with the identified embedding. For example—the output detector signature may be used for calculating the identified embedding. Yet for another example—the identified embedding is used for calculating the output detector signature.

An example for a signature, a cropping and an embedding is illustrated in U.S. patent application Ser. No. 18/595,368 filing date Mar. 4, 2024 which is incorporated herein by reference.

According to an embodiment, threshold changes over time. For example—the threshold is increased with an increase in a number of iterations of the iterative incremental learning process.

According to an embodiment, the increase of the threshold may be linked in any manner (for example—logarithmic manner or an exponential manner, or a linear manner or a non-linear manner) to the number of iterations.

According to an embodiment, the increase of the threshold may be linked in any manner (for example—logarithmic manner or an exponential manner, or a linear manner or a non-linear manner) to an improvement of accuracy of the classification. An increase in an accuracy of the classification may result in an increase in the threshold.

According to an embodiment, the increase of the threshold may be linked in any manner (for example—logarithmic manner or an exponential manner, or a linear manner or a non-linear manner) to at least one parameter related to driving a vehicle ad using the outcome of the incremental learning process (inference)—a complexity of a scenario expected to be faced by a vehicle during inference (higher complexity may increase the threshold), a danger expected to be faced by a vehicle during inference (higher danger level may increase the threshold), a damage expected to be faced by a vehicle during inference (higher expected damage—higher threshold), a status of safety elements (such as brakes of the vehicle) expected to be faced by a vehicle during inference, and the like.

According to an embodiment, the identified embedding is associated with an initial classification (related to the cluster to which the embedding was associated with a lower than threshold confidence level).

According to an embodiment, the method includes determining that the initial classification is a faulty classification when the initial classification differs from a classification associated with an additional cluster determined during the iteration.

According to an embodiment, there is provided method 200 for incremental learning classification capabilities.

According to an embodiment, method 200 is executed by a processing circuit and includes:

Step 210 of identifying, at each iteration of an iterative incremental learning process, that an embedding exhibits a clustering confidence level that is below a threshold, the embedding, generated at least in part by a machine learning process, representing a detector output that is responsive to a sensed information unit.

Step 220 of identifying, at each iteration by accessing a data structure associated with one or more reference detector output, signatures that are similar to a signature of the detector output.

Step 230 of determining, at each iteration, an additional cluster for an embedding associated with the detector output and for reference embeddings associated with the one or more reference detector output signatures.

The execution of steps 210-230 results in having each iteration of the iterative incremental process the identifying is based on at least one more determined cluster than a preceding iteration, and road elements associated with embeddings that fall within the determined cluster exhibit a clustering confidence level that is above the threshold and are classified, during inference, in accordance with the determined cluster.

According to an embodiment, step 230 includes retrieving the reference embeddings from a memory resource. The reference embeddings were calculated in the past and stores in one or more memory resources.

According to an embodiment, step 230 includes determining the reference embeddings based on the reference detector output signatures. This may include reconstructing the reference embedding from the reference detector output signatures.

According to an embodiment, step 230 includes determining the reference embeddings based on reference sensed information units associated with the reference detector output signatures. This may include generating the reference embeddings based on reference sensed information units.

According to an embodiment, step 230 includes updating, at least part of embeddings associated with previous iterations of the iterative incremental learning process. Thus—embeddings not related to the reference detector output signatures may be updated—for example by re-training or without retraining.

According to an embodiment, step 230 involves retraining, at least part, a process of generating of embeddings associated with previous iterations of the iterative incremental learning process.

According to an embodiment, step 230 at each iteration is performed without retraining embeddings of previous iterations.

According to an embodiment, at each iteration of the iterative incremental process the identifying is based on at least one more additional cluster than a preceding iteration, and road elements associated with embeddings that fall within the additional cluster exhibit a clustering confidence level that is above the threshold and are classified, during inference, in accordance with the additional cluster.

According to an embodiment, the number of iterations is unlimited.

According to an embodiment, the number of iteration is limited to a defined maximal number of iterations.

According to an embodiment an iteration refers to a case in which an embedding exhibits a clustering confidence level that is below a threshold. It is expected that in most cases embeddings are associated with clustering confidence levels above the threshold.

According to an embodiment the iterations end when the method converges.

Examples of convergence rules include:
A. When all the cases relevant to driving are properly classified.
B. When the application of the method achieves at least a desired classification accuracy—for example reaches a classification accuracy of at least 99, 99.9, 99.99, 99.999, 99.9999, 99.99999 percent accuracy.
C. When the application of the method achieves at least a desired tradeoff between at least two of false positive, false negative, true positive and true negative.
D. When a contribution of an iteration to the overall accuracy of classification is below a defined added accuracy value—for example below an accuracy improvement of 1-10 percent of the accuracy.

According to an embodiment, the threshold is determined in any manner—for example by simulation, by testing, by a vendor, by a client, by a vehicle manufacturer, and the like.

According to an embodiment, the threshold is determined to comply with a defined allowable value of false positive and/or an allowable value of false negative, and/or to provide a desired tradeoff between at least two of false positive, false negative, true positive and true negative.

According to an embodiment, the obtained detector output includes a region of interest indicator related to a specified region of interest. The region of interest indicator may be a bounding box.

According to an embodiment, the obtained detector output is indicative of a region of the sensed information to be used by a cropping process to generate a cropped sensed information unit.

According to an embodiment, the obtained detector output includes an initial classification of an item captured by the region of interest.

According to an embodiment, the generating of the detector output signature is in correlation with a signature associated with the identified embedding. For example—the output detector signature may be used for calculating the identified embedding. Yet for another example—the identified embedding is used for calculating the output detector signature.

An example for a signature, a cropping and an embedding is illustrated in U.S. patent application Ser. No. 18/595,368 filing date Mar. 4, 2024 which is incorporated herein by reference.

According to an embodiment, threshold changes over time. For example—the threshold is increased with an increase in a number of iterations of the iterative incremental learning process.

According to an embodiment, the increase of the threshold may be linked in any manner (for example—logarithmic manner or an exponential manner, or a linear manner or a non-linear manner) to the number of iterations.

According to an embodiment, the increase of the threshold may be linked in any manner (for example—logarithmic manner or an exponential manner, or a linear manner or a non-linear manner) to an improvement of accuracy of the classification. An increase in an accuracy of the classification may result in an increase in the threshold.

According to an embodiment, the increase of the threshold may be linked in any manner (for example—logarithmic manner or an exponential manner, or a linear manner or a non-linear manner) to at least one parameter related to driving a vehicle ad using the outcome of the incremental learning process (inference)—a complexity of a scenario expected to be faced by a vehicle during inference (higher complexity may increase the threshold), a danger expected to be faced by a vehicle during inference (higher danger level may increase the threshold), a damage expected to be faced by a vehicle during inference (higher expected damage—higher threshold), a status of safety elements (such as brakes of the vehicle) expected to be faced by a vehicle during inference, and the like.

According to an embodiment, the identified embedding is associated with an initial classification (related to the cluster to which the embedding was associated with a lower than threshold confidence level). According to an embodiment, the method includes determining that the initial classification is a faulty classification when the initial classification differs from a classification associated with an additional cluster determined during the iteration.

Any combination of any step of any method illustrated in the application is provided.

In the foregoing detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarding the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a device or system capable of executing the method and/or to a non-transitory computer readable medium that stores instructions for executing the method.

Any reference in the specification to a system or device should be applied mutatis mutandis to a method that may be executed by the system, and/or may be applied mutatis mutandis to non-transitory computer readable medium that stores instructions executable by the system.

Any reference in the specification to a non-transitory computer readable medium should be applied mutatis mutandis to a device or system capable of executing instructions stored in the non-transitory computer readable medium and/or may be applied mutatis mutandis to a method for executing the instructions.

Any combination of any module or unit listed in any of the figures, any part of the specification and/or any claims may be provided.

Any one of transformation module, active learning module, or clustering module, or any other module described herein, may be implemented in hardware and/or code, instructions and/or commands stored in a non-transitory computer readable medium, may be included in a vehicle, outside a vehicle, in a mobile device, in a server, and the like.

The vehicle may be any type of vehicle—such as a ground transportation vehicle, an airborne vehicle, or a water vessel.

The specification and/or drawings may refer to an image. An image is an example of sensed information. Any reference to an image may be applied mutatis mutandis to any type of natural signal such as but not limited to signal generated by nature, signal representing human behavior, signal representing operations related to the stock market, a medical signal, financial series, geodetic signals, geophysical, chemical, molecular, textual and numerical signals, time series, and the like. Any reference to a media unit may be applied mutatis mutandis to sensed information. The sensed information may be of any kind and may be sensed by any type of sensors—such as a visual light camera, an audio sensor, a sensor that may sense infrared, radar imagery, ultrasound, electro-optics, radiography, LIDAR (light detection and ranging), etc. The sensing may include generating samples (for example, pixel, audio signals) that represent the signal that was transmitted, or otherwise reach the sensor.

The specification and/or drawings may refer to a processor. The processor may be a processing circuitry (also referred to as a processing circuit). The processing circuitry may be implemented as a central processing unit (CPU), and/or one or more other integrated circuits such as application-specific integrated circuits (ASICs), field programmable gate arrays (FPGAs), full-custom integrated circuits, etc., or a combination of such integrated circuits.

Any combination of any steps of any method illustrated in the specification and/or drawings may be provided.

Any combination of any subject matter of any of claims may be provided.

Any combinations of systems, units, components, processors, sensors, illustrated in the specification and/or drawings may be provided.

Any reference to an object may be applicable to a pattern. Accordingly—any reference to object detection is applicable mutatis mutandis to a pattern detection.

A situation may be a singular location, or optionally a combination of properties identified at a specified point in time. A scenario is a series of events that follow logically within a causal frame of reference. Any reference to a scenario should be applied mutatis mutandis to a situation.

The sensed information unit may be sensed by one or more sensors of one or more types. The one or more sensors may belong to the same device or system—or may belong to different devices of systems.

We claim:

1. A method for incremental learning classification capabilities, the method comprises:
by a processing circuit:
identifying, at each iteration of an iterative incremental learning process, that an embedding exhibits a clustering confidence level that is below a threshold, the embedding, generated at least in part by a machine learning process, representing a detector output that is responsive to a sensed information unit;
identifying, at each iteration by accessing a data structure associated with one or more reference detector output, signatures that are similar to a signature of the detector output;
determining, at each iteration, an additional cluster for an embedding associated with the detector output and for reference embeddings associated with the one or more reference detector output signatures;
such that at each iteration of the iterative incremental process the identifying is based on at least one more determined cluster than a preceding iteration, and road elements associated with embeddings that fall within the determined cluster exhibit a clustering confidence level that is above the threshold and are classified, during inference, in accordance with the determined cluster.

2. The method according to claim 1, wherein the determining of the additional cluster comprises retrieving the reference embeddings from a memory resource.

3. The method according to claim 1, wherein the determining of the additional cluster comprises determining the reference embeddings based on the reference detector output signatures.

4. The method according to claim 1, wherein the determining of the additional cluster comprises determining the reference embeddings based on reference sensed information units associated with the reference detector output signatures.

5. The method according to claim 1, wherein the determining of the additional cluster involves updating, at least part of embeddings associated with previous iterations of the iterative incremental learning process.

6. The method according to claim 1, wherein the determining of the additional cluster involves retraining, at least part, a process of generating of embeddings associated with previous iterations of the iterative incremental learning process. The method according to claim 1, wherein the determining of the additional cluster at each iteration is performed without retraining embeddings of previous iterations.

7. The method according to claim 1, wherein the obtained detector output comprises a region of interest indicator related to a specified region of interest.

8. The method according to claim 1, wherein the generating of the detector output signature is in correlation with a signature associated with the identified embedding.

9. The method according to claim 1, wherein the threshold changes over time.

10. The method according to claim 1, comprising increasing the threshold with an increase in a number of iterations of the iterative incremental learning process.

11. The method according to claim 1, wherein for an iteration, the identified embedding is associated with an initial classification, wherein the method further comprises determining that the initial classification is a faulty classification when the initial classification differs from a classification associated with an additional cluster determined during the iteration.

12. The method according to claim 1, further comprising generating, by a signature generator and based on the identified embedding, the detector output signature.

13. The method according to claim 1, further comprising identifying that the identified embedding exhibits the clustering confidence level that is below the threshold.

14. A non-transitory computer readable medium for incremental learning classification capabilities, the non-transitory computer readable medium stores instructions executable by a processing circuit for:
identifying, at each iteration of an iterative incremental learning process, that an embedding exhibits a clustering confidence level that is below a threshold, the embedding, generated at least in part by a machine learning process, representing a detector output that is responsive to a sensed information unit;
identifying, at each iteration by accessing a data structure associated with one or more reference detector output, signatures that are similar to a signature of the detector output;
determining, at each iteration, an additional cluster for an embedding associated with the detector output and for reference embeddings associated with the one or more reference detector output signatures;
such that at each iteration of the iterative incremental process the identifying is based on at least one more determined cluster than a preceding iteration, and road elements associated with embeddings that fall within the determined cluster exhibit a clustering confidence level that is above the threshold and are classified, during inference, in accordance with the determined cluster.

15. The non-transitory computer readable medium according to claim 14, wherein the determining of the additional cluster comprises retrieving the reference embeddings from a memory resource.

16. The non-transitory computer readable medium according to claim 14, wherein the determining of the additional cluster comprises determining the reference embeddings based on the reference detector output signatures.

17. The non-transitory computer readable medium according to claim 14, wherein the determining of the additional cluster comprises determining the reference embeddings based on reference sensed information units associated with the reference detector output signatures.

18. The non-transitory computer readable medium according to claim 14, wherein the determining of the additional cluster involves updating, at least part of embeddings associated with previous iterations of the iterative incremental learning process.

19. The non-transitory computer readable medium according to claim 14, wherein the determining of the additional cluster involves retraining, at least part, a process of generating of embeddings associated with previous iterations of the iterative incremental learning process.

20. The non-transitory computer readable medium according to claim 1, wherein the determining of the additional cluster at each iteration is performed without retraining embeddings of previous iterations.
